(19) United States
(12) Patent Application Publication
(10) Pub. No.: US 2014/0251386 A1
(43) Pub. Date: Sep. 11, 2014

(54) PROCESSING APPARATUS AND PROCESSING METHOD

(71) Applicant: Kabushiki Kaisha Toshiba, Minato-ku (JP)

(72) Inventors: Shinichi Sasaki, Kanagawa-ken (JP); Katsuyuki Soeda, Kanagawa-ken (JP); Yukinobu Nishibe, Kanagawa-ken (JP)

(73) Assignee: Kabushiki Kaisha Toshiba, Minato-ku (JP)

(21) Appl. No.: 14/198,759

(22) Filed: Mar. 6, 2014

(30) Foreign Application Priority Data
Mar. 8, 2013 (JP) 2013-047261

(51) Int. Cl. B08B 3/02; B08B 3/04

(52) U.S. Cl. CPC B08B 3/022; B08B 3/041
USPC 134/30; 134/95.2

(57) ABSTRACT

According to one embodiment, a processing apparatus includes a rinsing section configured to rinse a processing liquid on a surface of a workpiece with a rinse liquid and a drying section configured to dry the surface of the workpiece. The drying section includes a chamber, a nozzle provided inside the chamber and configured to jet a gas toward the surface of the workpiece, an air flow control unit provided between the rinsing section and a space inside the chamber provided with the nozzle, and a plurality of transport rollers arranged along a transport direction of the workpiece. The air flow control unit includes a first opening provided on a side of receiving the workpiece and a second opening provided on a side of releasing the workpiece. Opening area of the second opening is smaller than opening area of the first opening.

### CROSS-REFERENCE TO RELATED APPLICATIONS

This application is based upon and claims the benefit of priority from Japanese Patent Application No. 2013-047261, filed on Mar. 8, 2013; the entire contents of which are incorporated herein by reference.

### FIELD

Embodiments described herein relate generally to a processing apparatus and a processing method.

### BACKGROUND

There is known a substrate with an amorphous silicon layer formed on the surface. Because of high activity, amorphous silicon is likely to react with oxygen and moisture in air to form silicon oxide containing impurity such as organic matter in air.

Thus, hydrogen fluoride is supplied to the surface of the amorphous silicon layer to remove silicon oxide and the like. Subsequently, pure water is supplied to the surface of the amorphous silicon layer to rinse residual hydrogen fluoride. Then, a gas is jetted from a slit-shaped nozzle toward the surface of the amorphous silicon layer to dry the surface of the amorphous silicon layer.

However, water on the surface of the amorphous silicon layer may be stirred up as mist by the gas jetted from the slit-shaped nozzle, and reattached to the dried surface of the amorphous silicon layer.

In this case, if water is reattached to the dried surface of the amorphous silicon layer, a water mark (circular deposit of silicon oxide) may be formed on the surface of the amorphous silicon layer.

### BRIEF DESCRIPTION OF THE DRAWINGS

FIG. 1 is a schematic view for illustrating a processing apparatus 1 according to the embodiment;

FIGS. 2A and 2B are schematic views for illustrating air flow according to a comparative example; and

FIGS. 3A and 3B are schematic views for illustrating air flow in the case where the air flow controlling unit 46 including the opening 46a is provided.

### DETAILED DESCRIPTION

According to one embodiment, a processing apparatus includes a rinsing section configured to rinse a processing liquid on a surface of a workpiece with a rinse liquid and a drying section configured to dry the surface of the workpiece. The drying section includes a chamber, a nozzle provided inside the chamber and configured to jet a gas toward the surface of the workpiece, an air flow controlling unit provided between the rinsing section and a space inside the chamber provided with the nozzle, and a plurality of transport rollers arranged along a transport direction of the workpiece. The air flow controlling unit includes a first opening provided on a side of receiving the workpiece and a second opening provided on a side of releasing the workpiece. Opening area of the second opening is smaller than opening area of the first opening.

Embodiments will now be illustrated with reference to the drawings. In the drawings, similar components are labeled with like reference numerals, and the detailed description thereof is omitted appropriately.

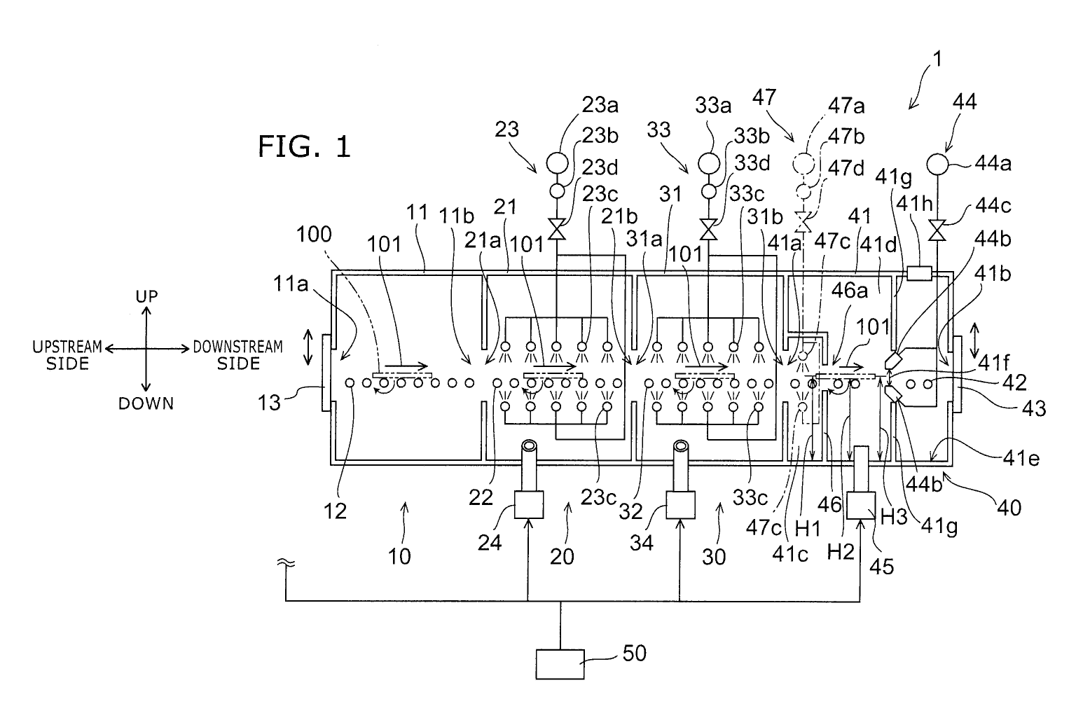

FIG. 1 is a schematic view for illustrating a processing apparatus 1 according to the embodiment.

As shown in FIG. 1, the processing apparatus 1 includes a receiving section 10, a processing section 20, a rinsing section 30, a drying section 40, and a control unit 50.

The receiving section 10 includes a chamber 11, a transport roller 12, and a gate 13. The chamber 11 is shaped like a box. At the walls on the upstream side and the downstream side in the transport direction 101 of a workpiece 100, the chamber 11 includes an opening 11a and an opening 11b for passing the workpiece 100.

The transport roller 12 is provided in a plurality inside the chamber 11. The plurality of transport rollers 12 are arranged along the transport direction 101 of the workpiece 100 at a prescribed spacing. The transport roller 12 is rotated by a drive unit, not shown. By the rotation of the transport roller 12, the workpiece 100 placed on the transport roller 12 is transported in the transport direction 101.

The gate 13 opens and closes the opening 11a of the chamber 11 by a drive unit, not shown.

The processing section 20 processes the surface of the workpiece 100 with a processing liquid.

The processing section 20 includes a chamber 21, a transport roller 22, a processing liquid supplying section 23, and an exhaust unit 24.

The chamber 21 is shaped like a box. At the walls on the upstream side and the downstream side in the transport direction 101 of the workpiece 100, the chamber 21 includes an opening 21a and an opening 21b for passing the workpiece 100.

The transport roller 22 is provided in a plurality inside the chamber 21. The plurality of transport rollers 22 are arranged along the transport direction 101 of the workpiece 100 at a prescribed spacing. The transport roller 22 is rotated by a drive unit, not shown. By the rotation of the transport roller 22, the workpiece 100 placed on the transport roller 22 is transported in the transport direction 101.

The processing liquid supplying section 23 includes a storing unit 23a, a liquid feeding unit 23b, a supply nozzle 23c, and a control unit 23d.

The storing unit 23a stores the processing liquid. The processing liquid can be appropriately selected depending on the matter to be removed. For instance, in the case of removing oxide on the surface of the workpiece 100, the processing liquid can be hydrogen fluoride or the like.

The liquid feeding unit 23b feeds the supply nozzle 23c with the processing liquid stored in the storing unit 23a. The liquid feeding unit 23b can be e.g. a chemical pump.

The supply nozzle 23c jets the processing liquid fed by the liquid feeding unit 23b toward the surface of the workpiece 100. The supply nozzle 23c is provided in a plurality inside the chamber 21. The plurality of supply nozzles 23c are arranged along the transport direction 101 of the workpiece 100 at a prescribed spacing.

The control unit 23d controls the flow rate of the processing liquid jetted from the supply nozzle 23c. Furthermore, the control unit 23d can also switch supplying and stopping of the processing liquid to the supply nozzle 23c.

The exhaust unit 24 evacuates gas and mist inside the chamber 21.

The exhaust unit 24 is attached so that evacuation is performed from the sidewall of the chamber 21 in order to reduce the takeout of the processing liquid.

Although not shown, a recovering unit for recovering the used processing liquid can also be provided.

The rinsing section 30 rinses the processing liquid on the surface of the workpiece 100 with a rinse liquid.

The rinsing section 30 includes a chamber 31, a transport roller 32, a rinse liquid supplying section 33, and an exhaust unit 34.

The chamber 31 is shaped like a box. At the walls on the upstream side and the downstream side in the transport direction 101 of the workpiece 100, the chamber 31 includes an opening 31a and an opening 31b for passing the workpiece 100.

The transport roller 32 is provided in a plurality inside the chamber 31. The plurality of transport rollers 32 are arranged along the transport direction 101 of the workpiece 100 at a prescribed spacing. The transport roller 32 is rotated by a drive unit, not shown. By the rotation of the transport roller 32, the workpiece 100 placed on the transport roller 32 is transported in the transport direction 101.

The rinse liquid supplying section 33 includes a storing unit 33a, a liquid feeding unit 33b, a supply nozzle 33c, and a control unit 33d.

The storing unit 33a stores the rinse liquid. The rinse liquid can be e.g. carbonated water. Use of carbonated water can prevent the workpiece 100 from being electrically charged. Thus, electrostatic breakdown can be prevented.

The liquid feeding unit 33b feeds the supply nozzle 33c with the rinse liquid stored in the storing unit 33a. The liquid feeding unit 33b can be e.g. a pump for pure water.

The supply nozzle 33c jets the rinse liquid fed by the liquid feeding unit 33b toward the surface of the workpiece 100. The supply nozzle 33c is provided in a plurality inside the chamber 31. The plurality of supply nozzles 33c are arranged along the transport direction 101 of the workpiece 100 at a prescribed spacing.

The control unit 33d controls the flow rate of the rinse liquid jetted from the supply nozzle 33c. Furthermore, the control unit 33d can also switch supplying and stopping of the rinse liquid to the supply nozzle 33c. The exhaust unit 34 evacuates gas and mist inside the chamber 31.

The exhaust unit 34 is attached so that evacuation is performed from the sidewall of the chamber 31 in order to reduce the takeout of the processing liquid.

Although not shown, a recovering unit for recovering the used rinse liquid can also be provided.

The drying section 40 blows a gas to the surface of the workpiece 100 to purge the rinse liquid on the surface of the workpiece 100 to the upstream side in the transport direction 101, and to dry the surface of the workpiece 100.

The drying section 40 includes a chamber 41, a transport roller 42, a gate 43, a gas supplying section 44, an exhaust unit 45, and an air flow controlling unit 46.

The chamber 41 is shaped like a box. At the walls on the upstream side and the downstream side in the transport direction 101 of the workpiece 100, the chamber 41 includes an opening 41a and an opening 41b for passing the workpiece 100.

The transport roller 42 is provided in a plurality inside the chamber 41. The plurality of transport rollers 42 are arranged along the transport direction 101 of the workpiece 100 at a prescribed spacing. The transport roller 42 is rotated by a drive unit, not shown. By the rotation of the transport roller 42, the workpiece 100 placed on the transport roller 42 is transported in the transport direction 101.

The gate 43 opens and closes the opening 41b of the chamber 41 by a drive unit, not shown.

The gas supplying section 44 includes a storing unit 44a, a nozzle 44b, and a control unit 44c.

The storing unit 44a stores a pressurized gas.

In the aforementioned processing section 20, oxide and the like on the surface of the workpiece 100 are removed. Then, an easily oxidizable substance (e.g., amorphous silicon) is exposed at the surface of the workpiece 100. In such cases, if a gas containing oxygen and moisture is used, a water mark is easily formed on the surface of the workpiece 100. Thus, preferably, the gas stored in the storing unit 44a is a gas free from oxygen and moisture. The gas free from oxygen and moisture can be e.g. an inert gas such as nitrogen gas, argon gas, and helium gas.

The nozzle 44b jets the gas supplied from the storing unit 44a toward the front surface and the rear surface of the workpiece 100. The nozzle 44b can be a slit-shaped nozzle (air knife). The nozzle 44b is provided inside the chamber 41 at a position above the workpiece 100 and a position below the workpiece 100, one for each. The nozzle 44b is obliquely provided so that the tip side of the nozzle 44b is located on the upstream side in the transport direction 101 of the workpiece 100. Thus, by the gas blown to the surface of the workpiece 100, the rinse liquid on the surface of the workpiece 100 can be purged to the upstream side in the transport direction 101, and the surface of the workpiece 100 can be dried.

At the position where the slit-shaped nozzle 44b is provided, a partition unit 41g for partitioning the upstream side of the nozzle 44b and the downstream side of the nozzle 44b is provided. The partition unit 41g includes an opening 41f for passing the workpiece 100. The partition unit 41g thus provided can suppress that mist generated on the upstream side of the nozzle 44b is attached to the dried surface of the workpiece 100. Furthermore, on the downstream side of the partition unit 41g, a fan filter unit 41h is provided. The fan filter unit 41h is provided at the wall (e.g., ceiling) of the chamber 41. The fan filter unit 41h includes an evacuation fan and a filter for capturing particles and the like. On the downstream side of the partition unit 41g, the fan filter unit 41h evacuates the inside of the chamber 41. The fan filter unit 41h thus provided can suppress contamination of the dried workpiece 100 with particles and the like.

The control unit 44c controls the flow rate of the gas jetted from the nozzle 44b. The control unit 44c can also switch supplying and stopping of the gas to the nozzle 44b.

The exhaust unit 45 evacuates gas and mist inside the chamber 41.

The exhaust unit 45 is provided on the upstream side of the partition unit 41g.

The exhaust unit 45 is attached so that evacuation is performed from the bottom surface side of the chamber 41 in order to avoid stirring up mist.

Although not shown, a recovering unit for recovering the water and the like purged from the surface of the workpiece 100 can also be provided.

The air flow controlling unit 46 controls air flow in the space 41d inside the chamber 41. Furthermore, the air flow controlling unit 46 suppresses that mist inside the chamber 31 flows into the space 41d inside the chamber 41.

The air flow controlling unit 46 is shaped like a box. The air flow controlling unit 46 is provided between the rinsing section 30 and the space 41d inside the chamber 41 provided with the nozzle 44b.

The air flow controlling unit 46 is provided so as to cover the opening 41a of the chamber 41 and to protrude into the chamber 41. That is, the air flow controlling unit 46 partitions the space inside the chamber 41 near the opening 41a (the space 41c inside the air flow controlling unit 46) and the space 41d inside the chamber 41 provided with the nozzle 44b. The space 41d is a space on the upstream side of the partition unit 41g.

At the wall of the air flow controlling unit 46 on the downstream side in the transport direction 101, an opening 46a (corresponding to an example of the second opening) is provided.

That is, the air flow controlling unit 46 includes an opening (corresponding to an example of the first opening) provided on the side of receiving the workpiece 100 and an opening 46a provided on the side of releasing the workpiece 100. In the embodiment, the opening provided on the side of receiving the workpiece 100 is the opening 41a of the chamber 41.

Thus, the space 41c inside the air flow controlling unit 46 communicates with the space inside the chamber 31 through the opening 41a and the opening 31b. Furthermore, the space 41c inside the air flow controlling unit 46 communicates with the space 41d provided with the nozzle 44b inside the chamber 41 through the opening 46a.

The opening 46a is provided to pass the workpiece 100, and to control air flow in the space 41d inside the chamber 41 and to suppress inflow of mist on the chamber 31 side into the space 41d.

The opening area of the opening 46a is smaller than the opening area of the opening 41a.

In this case, preferably, the dimension H1 from the bottom surface 41e of the chamber 41 to the center position of the opening 46a is made equal to the dimension H2 from the bottom surface 41e of the chamber 41 to the upper surface of the transport roller 42 for transporting the workpiece 100.

Typically, the thickness dimension of the workpiece 100 is short. Thus, the dimension H1 from the bottom surface 41e of the chamber 41 to the center position of the opening 46a may be made equal to the dimension H3 from the bottom surface 41e of the chamber 41 to the center position in the thickness direction of the workpiece 100.

This facilitates forming an air flow 145 having a fast flow velocity and flowing along the transport direction 101 of the workpiece 100.

The details on the function and effect of the air flow controlling unit 46 including the opening 46a will be described later.

Furthermore, the air flow controlling unit 46 can include a reaction suppressing section 47.

As described above, in the processing section 20, oxide and the like on the surface of the workpiece 100 are removed. Then, an easily oxidizable substance (e.g., amorphous silicon) is exposed at the surface of the workpiece 100. Thus, preferably, the surface of the workpiece 100 is covered with a liquid such as pure water until immediately before a gas is blown to the surface of the workpiece 100 by the nozzle 44b.

The reaction suppressing section 47 includes a storing unit 47a, a liquid feeding unit 47b, a supply nozzle 47c, and a control unit 47d.

The storing unit 47a stores a liquid such as pure water. In this case, the liquid stored in the storing unit 47a can be e.g. the aforementioned rinse liquid. The liquid feeding unit 47b feeds the supply nozzle 47c with the liquid stored in the storing unit 47a. The liquid feeding unit 47b can be e.g. a pump for pure water.

The supply nozzle 47c jets the liquid fed by the liquid feeding unit 47b toward the surface of the workpiece 100.

The control unit 47d controls the flow rate of the liquid jetted from the supply nozzle 47c. Furthermore, the control unit 47d can also switch supplying and stopping of the liquid to the supply nozzle 47c.

Here, with the increase in the amount of liquid jetted from the supply nozzle 47c, mist generated in the space 41c inside the air flow controlling unit 46 is made more likely to flow into the space 41d. The amount of liquid jetted from the supply nozzle 47c only needs to be such that the surface of the workpiece 100 is covered with the liquid. Thus, the amount of liquid jetted from the supply nozzle 47c can be made much smaller than the amount of rinse liquid jetted from the supply nozzle 33c in the rinsing section 30. Furthermore, the reaction suppressing section 47 is not necessarily needed, but can be appropriately provided as necessary.

The control unit 50 controls the operation of the components provided in the processing apparatus 1.

The control unit 50 controls the operation of e.g. the transport roller 12, the gate 13, the transport roller 22, the liquid feeding unit 23b, the control unit 23d, the exhaust unit 24, the transport roller 32, the liquid feeding unit 33b, the control unit 33d, the exhaust unit 34, the transport roller 42, the gate 43, the control unit 44c, the exhaust unit 45 and the like.

In the case illustrated above, the chamber 11, the chamber 21, the chamber 31, and the chamber 41 are separately formed and jointed together. However, they may be integrally formed. In this case, the opening 11b and the opening 21a, the opening 21b and the opening 31a, and the opening 31b and the opening 41a can be integrated, respectively.

The receiving section 10 is not necessarily needed, but can be provided as necessary.

Next, the function and effect of the air flow controlling unit 46 including the opening 46a are further described.

First, control of air flow in the space 41d inside the chamber 41 is described.

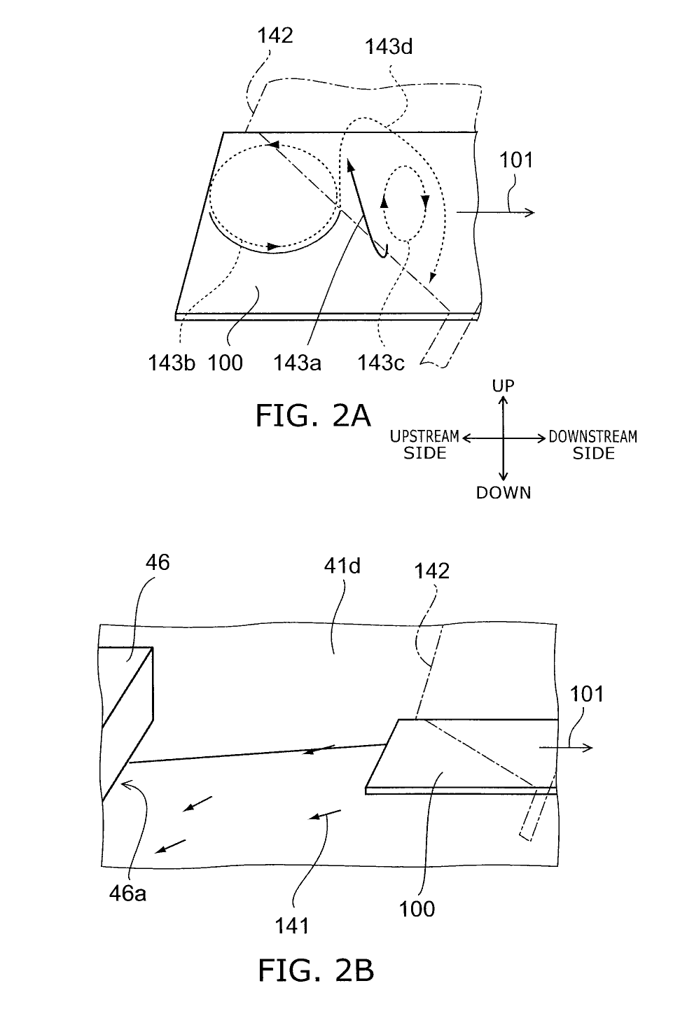

FIGS. 2A and 2B are schematic views for illustrating air flow according to a comparative example.

FIGS. 2A and 2B show a simulated air flow inside the chamber 41 in the case where the opening 46a of the air flow controlling unit 46 extends to the bottom surface of the chamber 41.

FIG. 2A is a schematic view for illustrating the process in which an air flow 143d falling toward the upper surface side of the workpiece 100 is formed.

FIG. 2B is a schematic view for illustrating an air flow 141 in the space 41d inside the chamber 41.

As shown in FIG. 2A, the gas 142 jetted from the nozzle 44b is blown to the upper surface of the workpiece 100, and then spread along the upper surface of the workpiece 100. In this case, the frictional resistance between the gas 142 and the gas in the space above the workpiece 100 is smaller than the frictional resistance between the gas 142 and the upper surface of the workpiece 100. Thus, an air flow 143a toward the upside of the workpiece 100 is formed.

When the air flow 143a toward the upside of the workpiece 100 is formed, convections 143b and 143c in the opposite direction are formed before and after the air flow 143a (on the upstream side and the downstream side in the transport direction 101). Then, when the convections 143b and 143c in the opposite direction are formed, an air flow 143d rising from the upper surface side of the workpiece 100, traveling to the downstream side in the transport direction 101, and then falling toward the upper surface side of the workpiece 100 is formed between the convection 143b and the convection 143c.

The downstream side of the position where the gas 142 jetted from the nozzle 44b has impinged on the upper surface of the workpiece 100 is a dried surface. Thus, mist of the rinse liquid formed by the gas 142 blown from the nozzle 44b may be carried by the air flow 143d and attached to the dried surface. If the mist of the rinse liquid is attached to the dried surface, a water mark may be formed on the upper surface of the workpiece 100.

As shown in FIG. 2B, the gas flowing out from the end on the upstream side of the workpiece 100 flows toward the opening 46a. Thus, an air flow 141 from the upper surface of the workpiece 100 toward the opening 46a is formed more easily. That is, an air flow 141 from the upper surface of the workpiece 100 downward on the upstream side is formed more easily.

Formation of such an air flow 141 encourages formation of the aforementioned air flow 143d. Thus, a water mark is formed more easily.

In the case where the gas 142 jetted from the nozzle 44b is blown to the lower surface of the workpiece 100, an air flow falling from the lower surface side of the workpiece 100, traveling to the downstream side in the transport direction 101, and then rising toward the lower surface side of the workpiece 100 is formed. However, an air flow 141 from the upper surface of the workpiece 100 downward on the upstream side is formed. This hampers formation of air flow rising toward the lower surface side of the workpiece 100.

Thus, in the comparative example illustrated in FIGS. 2A and 2B, a water mark is formed more easily on the upper surface of the workpiece 100.

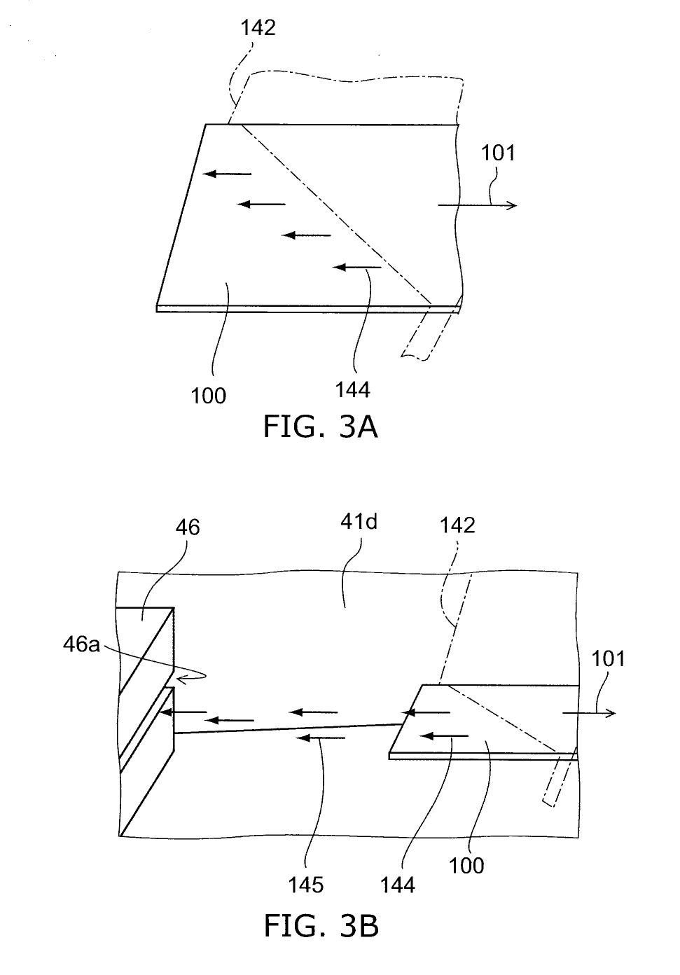

FIGS. 3A and 3B are schematic views for illustrating air flow in the case where the air flow controlling unit 46 including the opening 46a is provided.

FIGS. 3A and 3B show a simulated air flow inside the space 41d in the case where the air flow controlling unit 46 including the opening 46a is provided.

FIG. 3A is a schematic view for illustrating an air flow 144 near the upper surface side of the workpiece 100.

FIG. 3B is a schematic view for illustrating an air flow 145 in the space 41d inside the chamber 41.

The gas flowing out from the end on the upstream side of the workpiece 100 flows toward the opening 46a.

Thus, as shown in FIG. 3B, along the transport direction 101 of the workpiece 100, an air flow 145 flowing toward the upstream side in the transport direction 101 is formed more easily.

Furthermore, the opening area of the opening 46a is smaller than the opening area of the opening 41a. Thus, the flow velocity of the air flow 145 is faster than the flow velocity of the air flow 141.

Formation of the air flow 145 having a fast flow velocity and flowing along the transport direction 101 of the workpiece 100 hampers formation of the aforementioned air flow 143a toward the upside of the workpiece 100.

Thus, as shown in FIG. 3A, the gas 142 jetted from the nozzle 44b is blown to the upper surface of the workpiece 100, and then forms an air flow 144 flowing along the upper surface of the workpiece 100.

That is, formation of the air flow 143d rising from the upper surface side of the workpiece 100, traveling to the downstream side in the transport direction 101, and then falling toward the upper surface side of the workpiece 100 is hampered. This can suppress formation of a water mark.

This also applies similarly to the case where the gas 142 jetted from the nozzle 44b is blown to the lower surface of the workpiece 100.

Next, suppression of inflow of mist on the chamber 31 side into the space 41d is described.

The air flow controlling unit 46 is provided so as to cover the opening 41a of the chamber 41 and to protrude into the chamber 41. In the space 41c inside the air flow controlling unit 46, no or little liquid is jetted. Thus, the amount of mist inside the space 41c is much smaller than the amount of mist in the space inside the chamber 31.

Thus, the air flow controlling unit 46 is interposed between the chamber 31 containing a large amount of mist and the space 41d inside the chamber 41. This can suppress that the mist inside the chamber 31 flows into the space 41d.

Furthermore, as described above, by providing the air flow controlling unit 46 including the opening 46a, an air flow 145 having a fast flow velocity and flowing from the space 41d inside the chamber 41 through the space 41c inside the air flow controlling unit 46 toward the space inside the chamber 31 can be formed. This can further suppress that mist flows from the space inside the chamber 31 into the space 41c inside the air flow controlling unit 46. Thus, flow of mist into the space 41d can be further suppressed.

As a result, formation of a water mark can be suppressed.

The flow rate of the gas 142 jetted from the nozzle 44b is denoted by V1. The amount of evacuation of the exhaust unit 34 is denoted by V2. The amount of evacuation of the exhaust unit 45 is denoted by V3. The amount of evacuation of the fan filter unit 41h is denoted by V4. Then, setting V4>V3>V2>V1 facilitates forming an air flow 145 having a fast flow velocity. This can further suppress formation of a water mark.

Here, control of the flow rate V1, the amount of evacuation V2, the amount of evacuation V3, and the amount of evacuation V4 can be performed by the control unit 50.

Next, in conjunction with the function of the processing apparatus 1, a processing method according to the embodiment is illustrated.

First, the gate 13 is opened, and a workpiece 100 is transported into the chamber 11 through the opening 11a. The workpiece 100 transported into the chamber 11 is transported by the transport roller 12 into the chamber 21.

The workpiece 100 transported into the chamber 21 is transported by the transport roller 22. At this time, a processing liquid is jetted from the supply nozzle 23c toward the surface of the workpiece 100. By the processing liquid, for instance, oxide on the surface of the workpiece 100 is removed.

The workpiece 100 processed by the processing liquid is transported into the chamber 31 and transported by the transport roller 32. At this time, a rinse liquid is jetted from the supply nozzle 33c toward the surface of the workpiece 100. By the rinse liquid, the processing liquid on the surface of the workpiece 100 is rinsed.

After the processing liquid on the surface of the workpiece 100 is rinsed with the rinse liquid, the workpiece 100 is transported into the space 41c inside the air flow controlling unit 46. At this time, as necessary, a liquid is jetted from the supply nozzle 47c toward the surface of the workpiece 100. The amount of liquid jetted from the supply nozzle 47c is set much smaller than the amount of rinse liquid jetted from the supply nozzle 33c.

Subsequently, the workpiece 100 is transported by the transport roller 42 from the space 41c inside the air flow controlling unit 46 to the space 41d provided with the nozzle 44b inside the chamber 41. At this time, by blowing a gas from the nozzle 44b to the surface of the workpiece 100, the rinse liquid on the surface of the workpiece 100 is purged to the upstream side in the transport direction 101, and the surface of the workpiece 100 is dried.

By the function of the air flow controlling unit 46 including the opening 46a, an air flow 145 having a fast flow velocity and flowing along the transport direction 101 of the workpiece 100 is formed. By forming an air flow 145 having a fast flow velocity and flowing along the transport direction 101 of the workpiece 100, formation of the air flow 143d rising from the upper surface side of the workpiece 100, traveling to the downstream side in the transport direction 101, and then falling toward the upper surface side of the workpiece 100 is hampered. This suppresses formation of a water mark.

As described above, the processing method according to the embodiment includes the step of rinsing the processing liquid on the surface of the workpiece 100 with a rinse liquid, and the step of drying the surface of the workpiece 100. In the step of drying the surface of the workpiece 100, a gas is blown to the surface of the workpiece 100 to dry the surface of the workpiece 100. At this time, the gas flowing out from the end on the upstream side of the workpiece 100 forms an air flow 145 flowing along the transport direction of the workpiece 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A processing apparatus comprising:
a rinsing section configured to rinse a processing liquid on a surface of a workpiece with a rinse liquid; and
a drying section configured to dry the surface of the workpiece,
the drying section including:
a chamber;
a nozzle provided inside the chamber and configured to jet a gas toward the surface of the workpiece;
an air flow controlling unit provided between the rinsing section and a space inside the chamber provided with the nozzle; and
a plurality of transport rollers arranged along a transport direction of the workpiece,
the air flow controlling unit including a first opening provided on a side of receiving the workpiece and a second opening provided on a side of releasing the workpiece, and
opening area of the second opening being smaller than opening area of the first opening.

2. The apparatus according to claim 1, wherein the air flow controlling unit is shaped like a box.

3. The apparatus according to claim 1, wherein the air flow controlling unit is provided so as to protrude into the chamber.

4. The apparatus according to claim 1, wherein dimension from a bottom surface of the chamber to a center position of the second opening is equal to dimension from the bottom surface of the chamber to an upper surface of the transport rollers.

5. The apparatus according to claim 1, wherein dimension from a bottom surface of the chamber to a center position of the second opening is equal to dimension from the bottom surface of the chamber to a center position in a thickness direction of the workpiece.

6. The apparatus according to claim 1, wherein the nozzle is provided in a plurality.

7. The apparatus according to claim 6, wherein one of the plurality of nozzles is provided at a position above the workpiece and another of the plurality of nozzles is provided at a position below the workpiece.

8. The apparatus according to claim 1, wherein the nozzle is obliquely provided so that a tip side of the nozzle is located on an upstream side in the transport direction of the workpiece.

9. The apparatus according to claim 1, wherein the nozzle is a slit-shaped nozzle.

10. The apparatus according to claim 1, wherein the drying section further includes a partition unit provided inside the chamber and partitioning an upstream side of the nozzle and a downstream side of the nozzle.

11. The apparatus according to claim 10, wherein the drying section further includes a fan filter unit provided at a wall of the chamber on a downstream side of the partition unit.

12. The apparatus according to claim 10, wherein the drying section further includes an exhaust unit configured to evacuate inside of the chamber on an upstream side of the partition unit.

13. The apparatus according to claim 12, wherein the exhaust unit evacuates the inside of the chamber from a bottom surface side of the chamber.

14. The apparatus according to claim 11, wherein a formula
V4>V3>V1
is satisfied, where V1 is a flow rate of the gas jetted from the plurality of nozzles, V3 is amount of evacuation of an exhaust unit configured to evacuate inside of the chamber on an upstream side of the partition unit, and V4 is amount of evacuation of the fan filter unit.

15. The apparatus according to claim 1, wherein amorphous silicon is exposed at the surface of the workpiece.

16. The apparatus according to claim 1, wherein the gas includes at least one selected from the group consisting of nitrogen gas, argon gas, and helium gas.

17. The apparatus according to claim 1, wherein the rinse liquid includes carbonated water.

18. A processing method comprising:
rinsing a processing liquid on a surface of a workpiece with a rinse liquid; and
drying the surface of the workpiece,
in the drying the surface of the workpiece, when a gas is blown to the surface of the workpiece to dry the surface of the workpiece, the gas flowing out from an end of the workpiece forming an air flow flowing along a transport direction of the workpiece.

19. The method according to claim 18, wherein the gas flows toward an upstream side in the transport direction.

20. The method according to claim 18, wherein
amorphous silicon is exposed at the surface of the workpiece,
the gas includes at least one selected from the group consisting of nitrogen gas, argon gas, and helium gas, and
the rinse liquid includes carbonated water.
